(19) United States
(12) Patent Application Publication
(10) Pub. No.: US 2022/0304494 A1
(43) Pub. Date: Sep. 29, 2022

(54) Portable Blender with Heating and Cooling

(71) Applicant: BlendJet Inc., Concord, CA (US)

(72) Inventor: Ryan Michael Pamplin, San Juan, PR (US)

(21) Appl. No.: 17/211,420

(22) Filed: Mar. 24, 2021

(51) Int. Cl. A47J 27/00; A47J 43/08; F25B 21/04

(52) U.S. Cl. CPC A47J 27/004; A47J 43/085; F25B 21/04; F25B 2321/021; F25B 2400/01

(57) ABSTRACT

A blender that heats, cools, and blends foodstuffs within a container assembly is disclosed. Exemplary implementations may include a base assembly, the container assembly, an electrical motor, a blending component, a control interface, blending control circuitry, temperature control circuitry, and/or other components. The base assembly may include an electrical motor, a temperature-regulation sub-system and power sources. The temperature control circuitry may be configured to make a first type of detections regarding a temperature request by the user. The temperature control circuitry may control the temperature-regulation sub-system using one or more different temperature-regulation modes, a heating mode and a cooling mode, thus heating or cooling the foodstuffs, respectively, accordingly. The blending control circuitry may control the electrical motor to drive rotation of the blending component.

### FIELD OF THE DISCLOSURE

The present disclosure relates to portable blenders configured to blend foodstuffs and to heat or cool the foodstuffs.

### BACKGROUND

Blenders are known, typically as consumer-grade home appliances. User interfaces are known, e.g., for home appliances. Home appliances are usually not portable, not rechargeable, nor heat or cool foodstuffs while blending.

### SUMMARY

One aspect of the present disclosure relates to a blender configured to heat or cool foodstuffs. In some implementations, the blender may be portable due to its size, and/or its rechargeability. By virtue of true portability, a user can take the blender anywhere and create drinks, shakes, smoothies, baby food, sauces, and/or other concoctions. The blender may be charged wirelessly. By virtue of the control interface and the control circuitry described in this disclosure, different temperature-regulation modes may be used and different power modes of operation may be available to the user.

The blender may include a blending component, a base assembly, a container assembly, a control interface, blending control circuitry, temperature control circuitry, and/or other components. As used herein, the term “foodstuffs” may include ingredients ranging from solid to liquid, from hot to cold or frozen, in any combination. As used herein, the term “ingredient” merely connotates something fit to ingest, and not necessarily nutritional value. For example, ice and/or ice cubes may be ingredients. The blending component may be configured to rotate around a rotational axis and blend the foodstuffs during blending by the blender. The base assembly may include an electrical motor, a temperature-regulation sub-system, one or more power sources, and/or other components. The electrical motor may be configured to drive rotation of the blending component. The temperature-regulation sub-system may be configured to regulate the temperature of the foodstuffs within a container body during use of the blender by a user. The temperature-regulation sub-system may include one or more heating components, one or more cooling components, and/or other components. The one or more power sources may be configured to conduct electrical power to the electrical motor, to the temperature-regulation sub-system, and/or other components of the blender. In some implementations, the container assembly may be configured to hold the foodstuffs within a container body during blending by the blender. In some implementations, the control interface may be configured to control operation of the blender and regulate the temperature of the foodstuffs upon usage of the control interface by the user.

In some implementations, the temperature control circuitry may be configured to make a first type of detections regarding a temperature request by the user via the control interface. In some implementations, the temperature control circuitry may be configured to control, based on a first detection of the first type of detections, the temperature-regulation sub-system using one or more different temperature-regulation modes. The one or more different temperature-regulation modes may include at least a cooling mode and/or a heating mode, and/or other modes. Selection of either the cooling mode or the heating mode may be based on the first detection. In some implementations, responsive to selection of the heating mode, a first amount of electrical power may be provided by the one or more power sources to the one or more heating components to increase the temperature of the foodstuffs within the container body by providing heat, or removing cool air, or both. In some implementations, responsive to selection of the cooling mode, a second amount of electrical power may be provided by the one or more power sources to the one or more cooling components to decrease the temperature of the foodstuffs within the container body by cooling the foodstuffs, or removing warm air, or both. In some implementations, the blending control circuitry may be configured to make a second type of detections regarding controlling operation of the blender by the user via the control interface. In some implementations, the blending control circuitry may be configured control, based on a second detection of at least one of the first and second type of detections, the electrical motor during the rotation of the blending component. During blending, electrical power may be provided by the one or more power sources to the electrical motor, such that the blending component rotates and blends the foodstuffs within the container body.

As used herein, any association (or relation, or reflection, or indication, or correspondency) involving assemblies, blending components, blades, motors, rotational axes, longitudinal axes, diameters, batteries, couplings, interfaces, buttons, detectors, detections, indicators, magnetic components, rotations, rotational speeds, speed limits, modes of operation, amounts of electrical power, couplings, and/or another entity or object that interacts with any part of the blender and/or plays a part in the operation of the blender, may be a one-to-one association, a one-to-many association, a many-to-one association, and/or a many-to-many association or “N”-to-“M” association (note that “N” and “M” may be different numbers greater than 1).

As used herein, the term “effectuate” (and derivatives thereof) may include active and/or passive causation of any effect. As used herein, the term “determine” (and derivatives thereof) may include measure, calculate, compute, estimate, approximate, generate, and/or otherwise derive, and/or any combination thereof.

These and other features, and characteristics of the present technology, as well as the methods of operation and functions of the related components of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention. As used in the specification and in the claims, the singular form of “a”, “an”, and “the” include plural referents unless the context clearly dictates otherwise.

### BRIEF DESCRIPTION OF THE DRAWINGS

FIG. 1A shows a front view of a blender configured to heat, cool, and blend foodstuffs within a container body, in accordance with one or more implementations.

FIG. 1B shows a front view of a charging structure and a blender configured to heat, cool, and blend foodstuffs within a container body, in accordance with one or more implementations.

FIG. 2 shows a method for heating, cool, and blending foodstuffs within a contain body, in accordance with one or more implementations.

FIG. 3 illustrates a temperature-regulation sub-system, in accordance with one or more implementations.

### DETAILED DESCRIPTION

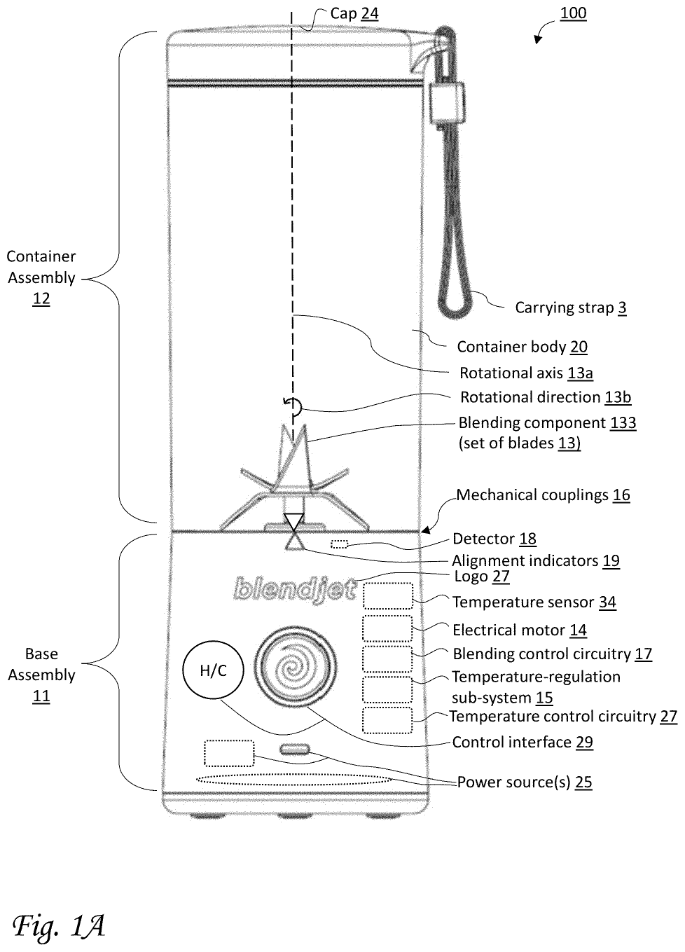

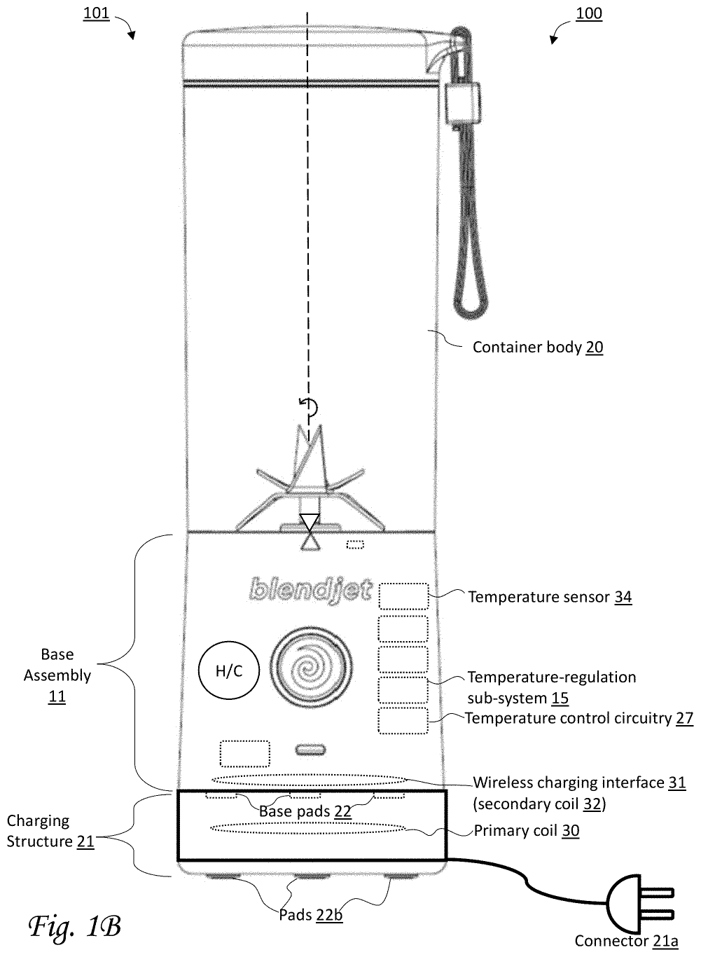

FIG. 1A shows a blender 100 configured to heat, cool, and blend foodstuffs within a container body 20, in accordance with one or more implementations. FIG. 1B shows a combination 101 of blender 100, the same as FIG. 1A, and a charging structure 21. Combination 101 may also be referred to as a blending system 101.

Referring to FIG. 1A, blender 100 may include one or more of a base assembly 11, container assembly 12, a blending component 133, a control interface 29, blending control circuitry 17 (depicted in FIG. 1A as a dotted rectangle to indicate this component may be embedded within base assembly 11, and not readily visible from the outside), temperature control circuitry 27 (depicted in FIG. 1A as a dotted rectangle to indicate this component may be embedded within base assembly 11, and not readily visible from the outside), power sources 25, and/or other components. In some implementations, base assembly 11 may include pads 22 (see FIG. 1A) at the bottom, e.g., for improved stability in an upright position.

Base assembly 11 and container assembly 12 may be configured to be coupled during blending by blender 100. For example, in some implementations, base assembly 11 and container assembly 12 may be mechanically coupled, e.g., through one or more mechanical couplings 16, which may be threaded. Other types of couplings may be envisioned for blender 100, though leak-proof options are preferred, since blender usage commonly includes one or more liquid ingredients. In some implementations, temperature control circuitry 27, temperature-regulation sub-system 15 (depicted in FIG. 1A as a dotted rectangle to indicate this component may be embedded within base assembly 11, and not readily visible from the outside), and/or other components may be included in base assembly 11, e.g., within base assembly 11. For example, one or more of control interface 29, blending control circuitry 17, temperature control circuitry 27, electrical motor 14 (depicted in FIG. 1A as a dotted rectangle to indicate this component may be embedded within base assembly 11, and not readily visible from the outside), temperature-regulation sub-system 15, power sources 25, and/or other components may be integrated permanently into base assembly 11 such that base assembly 11 forms an integral whole. In some implementations, the phrase “integrated permanently” may refer to components being integrated such that they are not readily accessible, serviceable, and/or replaceable by a user, or at least not during ordinary usage by the user, including, but not limited to, charging, blending, cleaning, and storing for later use.

In some implementations, base assembly 11 may include one or more of a base body (e.g., a housing configured to contain the components of base assembly 11), blending component 133 (e.g., a set of blades 13, also referred to as a set of one or more blades 13), electrical motor 14, temperature-regulation sub-system 15, power sources 25 (a charging port visible on the outside of blender 100 is depicted in FIG. 1A, a rechargeable battery is depicted in FIG. 1A as a dotted rectangle to indicate this component may be embedded within base assembly 11 and not readily visible from the outside, and a wireless charging interface is depicted in FIG. 1A as a dotted oval to indicate this component may be embedded within base assembly 11 and not readily visible from the outside), one or more mechanical couplings 16, a detector 18 (depicted in FIG. 1A as a dotted rectangle to indicate this component may be embedded within base assembly 11, and not readily visible from the outside), one or more alignment indicators 19, control interface 29 (depicted in FIG. 1A as being marked with a swirl symbol, and a “H/C” circle), and/or other components. The depiction in FIG. 1A of control interface 29 as having two separate components is exemplary and not intended to be limiting in any way.

In some implementations, one or more mechanical couplings 16 may include threaded couplings. For example, one or more mechanical couplings 16 may include a first mechanical coupling and a second mechanical coupling. In some implementations, the first mechanical coupling may be included in base assembly 11, and may be a female threaded coupling configured to fit together with the second mechanical coupling (which may be included in container assembly 12). Other implementations are envisioned within the scope of this disclosure. The first mechanical coupling and the second mechanical coupling may be configured to (temporarily and detachably) couple base assembly 11 to container assembly 12.

Blending component 133 may include one or more structural components configured to blend foodstuffs, including but not limited to one or more blending bars, one or more blades, and/or other structural components configured to rotate. For example, in some implementations, blending component 133 may include set of blades 13, which may be rotatably mounted to base assembly 11 to blend foodstuffs. Blending component 133 may be configured to rotate around a rotational axis 13a. Rotational axis 13a is depicted in FIG. 1A as a geometric two-dimensional line extending indefinitely through blending component 133, and is not a physical axis. Rather, rotational axis 13a indicates how blending component 133 rotates in relation to other components of blender 100, e.g., in a rotational direction 13b. In some implementations, blending component 133 may be mounted permanently to base assembly 11. In some implementations, set of blades 13 may include one, two, three, four, five, or more pairs of blades. In some implementations, a pair of blades may include two blades on opposite sides of rotational axis 13a. In some implementations, a pair of blades may have two blades such that the distal ends of these two blades are at the same horizontal level. In some implementations, as depicted in the upright configuration of blender 100 in FIG. 1A, set of blades 13 may include six blades that form three pairs of blades. In some implementations, set of blades 13 may include at least two downward blades, which may prevent and/or reduce foodstuffs remaining unblended when disposed under the upward blades. In some implementations, set of blades 13 may include at least four upward blades. In some implementations, including six blades may be preferred over including less than six blades, in particular for blending ice and/or ice cubes. By using more blades, more points of contact will hit the ice at substantially the same time, which reduces the likelihood that a piece of ice is merely propelled rather than broken, crushed, and/or blended, in particular for implementations using a limited amount of power (here, the term limited is used in comparison to non-portable counter-top blenders that are permanently connected to common outlets during blending), such as disclosed herein. As used herein, directional terms such as upward, downward, left, right, front, back, and so forth are relative to FIG. 1A unless otherwise noted.

Referring to FIG. 1B, charging structure 21 may be configured to support charging of blender 100. In some implementations, charging structure 21 may be powered through an external power source (not depicted) that is external to blender 100, e.g., through a connector 21a. In some implementations, connector 21a may be configured to plug into a socket and/or power supply. In some implementations, blender 100 may be configured to support other charging or power interfaces (in some cases, at the same time). In some implementations, charging structure 21 may include pads 22b at the bottom, e.g., for improved stability in an upright position. In some implementations, base assembly 11 and charging structure 21 may be coupled by way of one or more couplings (by way of non-limiting example, mechanically coupled, magnetically coupled, and/or otherwise coupled). In some implementations, base pads 22 may couple and/or connect with charging structure 21 as one of the couplings. The couplings and their functions may be further described in co-pending U.S. application Ser. No. 17/195,338 entitled “A PORTABLE BLENDER WITH WIRELESS CHARGING”, Attorney Docket No. 65XB-002040, the disclosure of which is incorporated by reference in its entirety herein.

In some implementations, charging structure 21 may be configured to support wireless charging, such as, e.g., inductive charging, via a wireless charging interface 31 included in base assembly 11 (the same as the dotted oval depicted in FIG. 1A as to indicate this component may be embedded within base assembly 11 and not readily visible from the outside). Wireless charging interface 31 in base assembly 11 may include a secondary coil 32 and charging structure 21 may include a primary coil 30, such that primary coil 30 and secondary coil 32 support, including but not limited to (electromagnetic) inductive charging of the rechargeable battery (referred to in FIG. 1A and described herein) and/or inductive conducting of electrical power into blender 100 (through inductive coupling between primary coil 30 and secondary coil 32). In some implementations, charging structure 21 may be a dock or docking pad, e.g., as depicted in FIG. 1B. In some implementations, charging structure 21 may be a charging mat or charging pad.

Referring back to FIG. 1A, container assembly 12 may include one or more of container body 20, a cap 24 (e.g., to prevent spilling during blending), a carrying strap 3 (e.g., configured to carry blender 100), and/or other components. Container body 20 may form a vessel to hold and/or contain foodstuffs within container assembly 12. In some implementations, container assembly 12 and/or container body 20 may be a cylindrical body and/or have a cylindrical shape. In some implementations, container body 20 may be open at one or both ends. In some implementations, container body 20 may be closed at the bottom. In some implementations, the dimensions of container assembly 12 may be such that the internal volume of container assembly 12 can hold 8, 10, 12, 14, 16, 18, 20, 22, 24, 28, 32, 36, 48, or more ounces.

Electrical motor 14 may be configured to rotationally drive blending component 133. In some implementations, electrical motor 14 may operate at a voltage between 5V and 15V. In one or more preferential implementations, electrical motor 14 may operate at a voltage of about 7.4V. In some implementations, electrical motor 14 may be configured to operate at multiple different voltages, depending on the power supplied to electrical motor 14. For example, during a first mode of operation, electrical motor 14 may operate at a first voltage, during a second mode of operation, electrical motor 14 may operate at a second voltage that is higher than the first voltage, and so forth. In some implementations, electrical motor 14 may be a universal motor. In some implementations, electrical motor 14 may have a variable-frequency drive. In some implementations, electrical motor 14 may be a brushed DC electric motor.

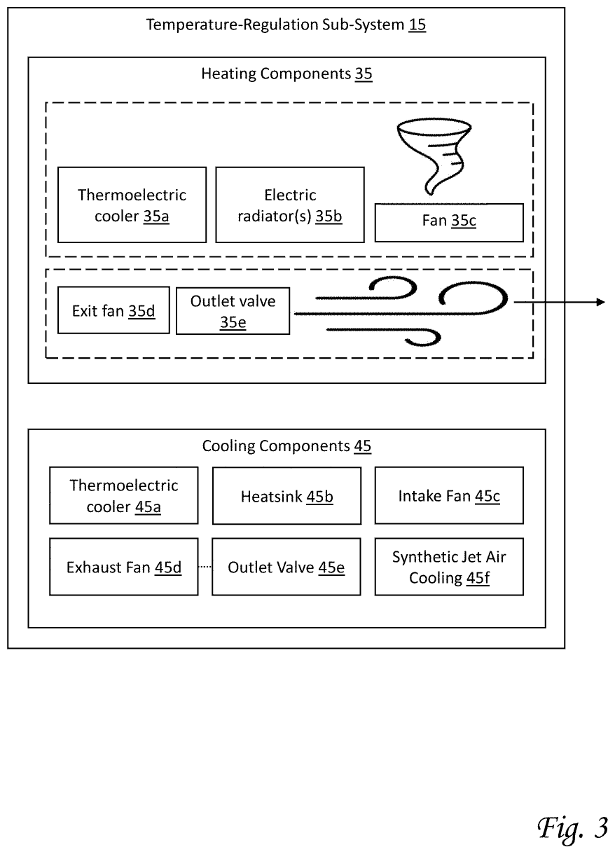

Temperature-regulation sub-system 15 may be configured to regulate the temperature of the foodstuffs within container body 20 during use of blender 100 by the user. Referring to FIG. 3, temperature-regulation sub-system 15 may include one or more heating components 35 and one or more cooling components 45. Temperature-regulation sub-system 15 may implement heating component 35, cooling component 45, or both responsive to temperature requests by the user via control interface 29. Operations by temperature-regulation sub-system 15 may be based on control by temperature control circuitry 27 and/or other components of blender 100. In some implementations, implementing both heating components 35 and cooling components 45 may facilitate attaining a particular interior temperature of container body 20 (and/or of the foodstuffs within container body 20). Simultaneously referring to FIG. 1A, heating component(s) 35 may be configured to provide heat to the foodstuffs contained in container body 20 responsive to receipt of the electrical power from power source(s) 25 (i.e., by using this electrical power). Cooling component(s) 45 may be configured to lower the temperature of the foodstuffs contained in container body 20 responsive to receipt of the electrical power from power source(s) 25 (i.e., by using this electrical power).

Heating components 35 may include one or more of a thermoelectric generator 35a, one or more electric radiators 35b, a fan 35c to distribute heat generated by one or both of thermoelectric generator 35a and one or more electric radiators 35b to provide heat, and/or other components. In some implementations, heating components 35 may include one or more of an exit fan 35d, an outlet valve 35e that transfers the cool air through outlet value 35e out of base assembly 11 to an atmosphere, and/or other components to remove cool air. In some implementations, the sizes of thermoelectric generator 35a and electric radiators 35b may vary such that a large thermoelectric generator 35a or a large electric radiator 35b may provide more heat than a small thermoelectric generator 35a or electric radiator 35b, respectively.

Cooling component 45 may include one or more of a thermoelectric cooler 45a, a heat sink 45b, an intake fan 45c that draws in cooler air, an exhaust fan 45d that expels warm air to the atmosphere around blender 100, an outlet value 45e attached to the exhaust fan to expelling the warm air to the atmosphere, a synthetic jet air cooling 45f, and/or other cooling components. In some implementations, sizes of thermoelectric cooler 45a may vary such that a large thermoelectric cooler 45a may lower the temperature more (or more efficiently, or in less time) than a small thermoelectric cooler 45a.

Referring back to FIG. 1A, electrical motor 14 and temperature-regulation sub-system 15 may be configured to be powered, alternatively or simultaneously by power sources 25. Power sources 25 may include the charging port, the rechargeable battery, the wireless charging interface, and/or other charging interfaces, and/or other power sources. The charging port may be a universal serial bus (USB) port configured to receive an electrical connector, e.g., for the charging rechargeable battery and/or providing electrical power to electrical motor 14, temperature-regulation sub-system 15, and/or other components of blender 100. The electrical connector, if used, may be connected to an external power source. A USB port is merely one type of standardized charging interface and power source 25. Other standards are contemplated within the scope of this disclosure. In some implementations, power sources 25 may support (at least part of) the Qi wireless charging standard. In some implementations, power sources 25 may support (at least part of) other wireless charging standards widely adopted in the industry. In some implementations, power sources 25 may be covered for protection and/or other reasons. One or more power sources 25 may be configured to conduct electrical power to the rechargeable battery, temperature-regulation sub-system 15 and/or electrical motor 14. In some implementations, power sources 25 may be standardized.

The rechargeable battery may be configured to power electrical motor 14. In some implementations, and in some modes of operation, the rechargeable battery may be configured to power electrical motor 14 such that, during blending by blender 100, no power is supplied to electrical motor 14 from an external power source. In some implementations, the rechargeable battery may be non-removable. As used herein, the term “non-removable” may mean not accessible to users during common usage of blender 100, including charging, blending, cleaning, and storing for later use. In some implementations, the rechargeable battery may be not user-replaceable (in other words, non-removable). In some implementations, the rechargeable battery may be user-replaceable. In some implementations, the rechargeable battery may be store-bought. In some implementations, the rechargeable battery may have a capacity between 1000 mAh and 20000 mAh.

Detector 18 may be configured to detect whether mechanical couplings 16 are coupled in a manner operable and suitable for blending by blender 100. In some implementations, operation of detector 18 may use one or more magnetic components. For example, in some implementations, one or more magnetic components are included in container body 20. Engagement may be detected responsive to these one or more magnetic components being aligned and sufficiently close to one or more matching magnetic components that may be included in base assembly 11. In some implementations, blender 100 may include one or more alignment indicators 19, depicted in FIG. 1A as matching triangles, to visually aid the user in aligning base assembly 11 with container assembly 12 in a manner operable and suitable for blending. In some implementations, one or more alignment indicators 19 may be in the front, in the back, and/or in other parts of blender 100.

In some implementations, detector 18 may be configured to detect whether the one or more couplings between base assembly 11 and charging structure 21 of FIG. 1B are coupled in a manner operable and suitable for providing electrical power to blender 100 and blending by blender 100. In some implementations, operation of detector 18 may use one or more magnetic components, similar as described above.

Control interface 29 may be part of the user interface of blender 100. In some implementations, control interface 29 may include a temperature interface (depicted as being marked with a “H/C” in FIG. 1A) to receive user input (or temperature requests) for either heating or cooling) and a power interface (depicted as being marked with a swirl symbol FIG. 1A). In some implementations, control interface 29 may include one or more of a heat interface (e.g., depicted as being marked with an “H”, not pictured), a cool interface (e.g., depicted as being marked with a “C”, not pictured), a power interface, and/or other components. Through control interface 29, the user of blender 100 may control the operation of blender 100 and the operation of temperature-regulation sub-system 15, including but not limited to transitions between different modes of operation. In some implementations, control interface 29 may be configured to control the operation of blender 100 upon receiving user input from the user through control interface 29. For example, the different modes of operation may include multiple (power) modes of operation. In some implementations, the power modes of operation of blender 100 may include at least two power modes of operation: a first power mode of operation, a second power mode of operation, and/or other power modes of operation. For example, during various modes of operation of blender 100, blending control circuitry 17 may be configured to effectuate rotation of blending component 133 (in other words, to effectuate blending), e.g., for a particular duration. Alternatively, and/or simultaneously, the different modes of operations may include multiple temperature-regulation modes. In some implementations, the temperature-regulation modes of temperature-regulation sub-system 15 may include one or more temperature-regulation modes. In some implementations, the temperature-regulation modes of temperature-regulation sub-system 15 may include at least two temperature-regulation modes: a cooling mode, a heating mode, and/or other temperature-regulation modes. For example, during various temperature-regulation modes, temperature control circuitry 27 may be configured to effectuate heating components 35 and/or cooling components 45 described herein and depicted in FIG. 3 (in other words, to heat or cool the foodstuffs within container body 20, or to increase or decrease the temperature of the foodstuffs within container body 20).

In some implementations, control interface 29 may include one or more buttons to receive user input and temperature requests. For example, a button of control interface 29 may be configured to be pushed by the user (as used herein, a push may be released quickly or may be held down, or may be followed by one or more additional pushes, e.g., in the case of a double push). In some implementations, control interface 29 includes exactly one button. For example, in some implementations, the button may be the only user-manipulatable portion of control interface 29 (e.g., via push combinations), such that no other button or user interface component controls the operation of blender 100, controls the transitions between different modes of operation used by blender 100, or regulates temperature of the foodstuffs. In some implementations, control interface 29 may include two or more buttons, a touchscreen, and/or other interfaces. For example, in some implementations, a first button may be pushed by the user (e.g., a push combination via the first button) to indicate whether the temperature request corresponds to a first selection of the heating mode or a second selection of the cooling mode, and a second button may be pushed by the user to control operation (i.e., blending) and transitions between the power modes of operation. A particular temperature request may refer to whether the user selected the heating mode to heat the foodstuffs within container body 20 or the cooling mode to cool the foodstuffs. In some implementations, control interface 29 may include a third button and a fourth button only where the third button corresponds to controlling operation (i.e., blending) with the cooling mode and the fourth button corresponds to controlling operation with the heating mode. In some implementations, a touchscreen may enable the user to provide the temperature request, control operation of blender 100, and/or control transitions between modes of operation.

In some implementations, control interface 29 may include one or more controllable light-emitting components. For example, the light-emitting components may be light-emitting diodes (LEDs) or other types of lights. In some implementations, the one or more controllable light-emitting components may be configured to selectively light up. In some implementations, the one or more controllable light-emitting components may be configured to indicate, to the user, a current mode of operation of blender 100, an occurrence of a transition between different modes of operation, a warning for the user, a current charging mode, a current temperature-regulation mode (e.g., red for the heating mode and blue for the cooling mode), and/or other information regarding the operation of blender 100. For example, the one or more controllable light-emitting components may use different colors, intensities, patterns, sequences, and/or other combinations of light to provide information to the user. In some implementations, control interface 29 may include one or more controllable sound-emitting components, such as a speaker, configured to selectively emit sound. In some implementations, the one or more controllable sound-emitting components may be configured to indicate, to a user, a current mode of operation of blender 100, an occurrence of a transition between different modes of operation, a warning for the user, a current charging mode, a current temperature-regulation mode, and/or other information regarding the operation of blender 100. For example, the one or more controllable sound-emitting components may use different frequencies, volumes, patterns, sequences, and/or other combinations of sound to provide information to the user. In some implementations, control interface 29 may include one or more haptic components to provide feedback to a user.

Temperature control circuitry 27 may be configured to make and/or use different types of detections regarding blender 100. In some implementations, a first type of detections made by temperature control circuitry 27 may be regarding the particular temperature request by the user via control interface 29. For example, temperature control circuitry 27 may detect the first selection of the first button by the user, or released, or pushed again indicating selection of the heating mode or the cooling mode. By way of non-limiting example, a first detection of the first type of detections may be that the first button is pushed and released once indicating the heating mode, or pushed and released twice indicating the cooling mode.

In some implementations, temperature control circuitry 27 may be configured to control, based on the first detection of the first type of detections, temperature-regulation sub-system 15. Controlling temperature-regulation sub-system 15 may include causing power sources 25 to conduct, conducting, or control conduction of the electrical power to heating components 35, cooling components 45 of FIG. 3, or both. In some implementations, temperature control circuitry 27 may be configured to conduct (or control conduction of) the electrical power using at least two different temperature-regulation modes. The at least two different temperature-regulation modes may include the cooling mode, the heating mode, and/or other temperature-regulation modes. Usage and/or selection of one of the different temperature-regulation modes (e.g., either the heating mode, the cooling mode, etc.) by temperature control circuitry 27 may be based on the first detection. In some implementations, selection of one of the different temperature-regulation modes may be further based on third, and/or other types of detections. In some implementations, temperature control circuitry 27 may be implemented as a printed circuit board (PCB).

In some implementations, responsive to selection of the heating mode, a first amount of electrical power may be provided by power source(s) 25 to one or more of heating components 35 of FIG. 3 to increase the temperature of the foodstuffs within container body 20 by providing heat, removing cool air, or both. The heating mode may be selected by temperature control circuitry 27 upon at least the first detection indicating that the temperature request corresponds to the first selection of the heating mode. For example, the first button may have been pushed and released once by the user.

In some implementations, responsive to selection the cooling mode, a second amount of electrical power may be provided to by power source(s) 25 to one or more cooling components 45 of FIG. 3 to decrease the temperature of the foodstuffs within the container body by cooling the foodstuffs, removing warm air, or both. The cooling mode may be selected by temperature control circuitry 27 upon at least the first detection indicating the temperature request corresponds to the second selection of the cooling mode. For example, the first button may be have pushed and release twice by the user. In some implementations, the first amount of electrical power may be the same as the second amount of electrical power. In some implementations, the first amount of electrical power may be different than the second amount of electrical power. For example, the second amount of electrical power may be less than the first amount.

Referring to FIG. 1B, in some implementations, base assembly 11 may include one or more temperature sensors 34 (depicted as a dotted rectangle to indicate this component or components may be embedded within base assembly 11, and not readily visible from the outside) configured to determine an interior temperature of container body 20 containing the foodstuffs. Temperature control circuitry 27 may be configured to make a third type of detections regarding the interior temperature of container body 20 relative to a cool threshold and a heat threshold and based on one or more temperature sensors 34. The cool threshold may be a maximum temperature that the interior temperature may be to be considered cool/cold. The heat threshold may be a minimum temperature that the interior temperature may be to be considered heated. Detecting the interior temperature relative to the cool threshold and/or the heat threshold may facilitate controlling temperature-regulation sub-system 15 of FIG. 1A. That is, upon detecting that the interior temperature is a particular number of degrees away from the cool threshold, temperature control circuitry 27 may control heating components 35 and/or cooling components 45 of FIG. 3 accordingly. For example, upon the interior temperature being 50 degrees Fahrenheit and the cool threshold is 40 degrees Fahrenheit, more than one of cooling components 45 of FIG. 3 may be controlled/provided electrical power, particular cooling components 45 may be controlled, and/or particular cooling components 45 may be provided a particular amount of electrical power (to cool the foodstuffs) whereas upon the interior temperature being 42 degrees Fahrenheit, only one of cooling components 45 may be controlled/provided electrical power given that the interior temperature is closer to the cool threshold. Similarly, upon detecting that the interior temperature is a particular number of degrees away from the heat threshold (e.g., 73 degrees Fahrenheit), temperature control circuitry 27 may control heating components 35 and/or cooling components 45 of FIG. 3 accordingly such as controlling/providing electrical power to particular heating components 35 and/or providing a particular amount of electrical power to particular heating components 35.

For example, the heating mode may be used and/or selected by temperature control circuitry 27. In some implementations, two or more of cooling component 45 may be provided electrical power (to cool the foodstuffs, or remove warm air, or both) based on control by temperature control circuitry 27. In some implementations, operations by cooling components 45 may be responsive to a combination of different detections, such as, by way of non-limiting example, a first detection (being of a first type of detections) that the first button has been pushed to indicate the second selection of the cooling mode, a second detection (being of a second type of detections described herein) that the second button has been pushed, and a third detection (being of the third type of detections) that the interior temperature is above the cool threshold.

For example, the heating mode may be used and/or selected by temperature control circuitry 27. In some implementations, two or more of heating component 45 may be provided electrical power (to provide heat, or remove cool air, or both) based on control by temperature control circuitry 27. In some implementations, operations by heating components 35 may be responsive to a combination of different detections, such as, by way of non-limiting example, a first detection (being of a first type of detections) that the first button has been pushed to indicate the first selection of the heating mode, a second detection, and a third detection (being of the third type of detections) that the interior temperature is below the heat threshold.

Referring back to FIG. 1A, blending control circuitry 17 may be configured to control different functions and/or operations of blender 100, including but not limited to turning blender 100 on and off, transitioning between different modes of operation, controlling of electrical motor 14 regarding and/or during rotation of blending component 133, determining whether mechanical couplings 16 are engaged properly for blending, determining whether the couplings between base assembly 11 and charging structure 21 of FIG. 1B are engaged properly for blending, controlling or otherwise using control interface 29, and/or performing other functions for blender 100. In some implementations, blending control circuitry 17 may be configured to prevent rotation of blending component 133 responsive to certain determinations, including but not limited to a determination that mechanical couplings 16 are not engaged (or not engaged properly for the intended operation of blender 100). In some implementations, blending control circuitry 17 may be configured to use control interface 29 to convey information regarding the operational status of blender 100 to a user. For example, control interface 29 may include a light that can illuminate in various colors and/or patterns. In some implementations, blending control circuitry 17 may be implemented as a printed circuit board (PCB). In some implementations, temperature control circuitry 27 and blending control circuitry 17 may be implemented in a single PCB.

In some implementations, blending control circuitry 17 may be configured to make different types of detections that temperature control circuitry 27 makes regarding blender 100. In some implementations, a second type of detections may be made by blending control circuitry 17 regarding controlling operation of blender 100 (i.e., powering or running blending components 133) by the user via control interface 29. For example, blending control circuitry 17 may detect whether the second button of control interface 29 has been pushed by the user, or released, or pushed again.

In some implementations, blending control circuitry 17 may be configured to control electrical motor 14, e.g., during the rotation of blending component 133. Therefore, during blending, electrical power is provided by one or more power sources 25 to the electrical motor such that blending component 133 rotates and blends the foodstuffs within container body 20. In some implementations, control by blending control circuitry 17 may be based on a second detection of at least one of the first and the second type of detections. In some implementations, blending control circuitry 17 may be configured to control electrical motor 14 using at least two different power modes of operation, such as a first power mode of operation and a second power mode of operation. Various push combinations of control interface 29, such as the second button, may indicate usage of the different power modes of operation. Additional power modes of operation are envisioned within the scope of this disclosure. In some implementations, control by blending control circuitry 17 may be further based on one or more detections of other types of detections.

In some implementations, during the first power mode of operation, a third amount of electrical power may be provided by power source(s) 25 to electrical motor 14. The third amount of electrical power may be provided conjointly by multiple ones of power sources 25 (e.g., the rechargeable battery and the wireless charging interface). As used herein, the term “conjointly” refers to multiple sources of electrical power operating at the same time to provide electrical power, in this case to electrical motor 14 and/or other components of blender 100. In other words, power provided by one source may be combined with power provided by another source. In some implementations, during the second power mode of operation, a fourth amount of electrical power may be provided by power source(s) 25 to electrical motor 14 and/or other components of blender 100.

In some implementations, the third amount of electrical power may be greater than the fourth amount of electrical power. For example, in some implementations, the third amount of electrical power may be at least 20% greater than the fourth amount of electrical power. For example, in some implementations, the third amount of electrical power may be at least 30% greater, 40% greater, 50%, and/or 100% greater than the fourth amount of electrical power. Responsive to selection of the heating mode, the first power mode of operation may be selected and/or used by blending control circuitry 17 so that the third amount of electrical power is provided to electrical motor 14. Responsive to selection of the cooling mode, the second power mode of operation may be selected and/or used by blending control circuitry 17 so that the second amount of electrical power is provided to electrical motor 14. That is, during the heating mode, the third amount of electrical power may be provided to electrical motor 14 instead of the fourth amount because the greater third amount of electrical power, that may rotate blending component 133 faster, may contribute more heat for the heating. Conversely, during the cooling mode, the fourth amount of electrical power may be provided to electrical motor 14 because the slower rotation of blending component 133 may contribute less heat during the cooling.

In some implementations, electrical motor 14 may be configured to rotate blending component 133 at a particular rotational speed. In some implementations, the rotational speed may be limited by a particular rotational speed limit. In some implementations, the particular rotational speed and/or the particular rotational speed limit may be controlled, e.g., by blending control circuitry 17, such that different power modes of operation correspond to different rotational speeds and/or rotational speed limits. For example, during the first power mode of operation, electrical motor 14, and thus blending component 133, may be configured to rotate using a first rotational speed and/or limited by a first rotational speed limit. For example, during the second power mode of operation, electrical motor 14, and thus blending component 133, may be configured to rotate using a second rotational speed and/or limited by a second rotational speed limit, and so forth. In some implementations, blending control circuitry 17 may be configured to control electrical motor 14 during rotation of blending component 133. For example, blending control circuitry 17 may control the speed of the rotation of blending component 133 during blending by blender 100. In some implementations, the first rotational speed limit may be greater than the second rotational speed limit. For example, in some implementations, the first rotational speed limit may be at least 20% greater than the second rotational speed limit. For example, in some implementations, the first rotational speed limit may be at least 30% greater, 40% greater, 50%, and/or 100% greater than the second rotational speed limit. Alternatively, and/or simultaneously, in some implementations, the output wattage of electrical motor 14 during the first power mode of operation may be about 20%, about 30%, about 40%, about 50%, and/or about 100% greater than the output wattage during the second power mode of operation. Alternatively, and/or simultaneously, in some implementations, the torque of electrical motor 14 during the first power mode of operation may be about 20%, about 30%, about 40%, about 50%, and/or about 100% greater than the torque during the second power mode of operation.

In some implementations, blender 100's maximum rotational speed may range between 15,000 rotations per minute (RPM) and 40,000 RPM. In some implementations, blender 100's maximum rotational speed may range between 10,000 rotations per minute (RPM) and 50,000 RPM. In one or more implementations, electrical motor 14 may rotate blending component 133 at a rotational speed of about 16,500 RPM (e.g., during a second power mode of operation). In one or more implementations, electrical motor 14 may rotate blending component 133 at a rotational speed ranging between about 20,000 RPM and about 25,000 RPM (e.g., during a first power mode of operation). In one or more implementations, electrical motor 14 may rotate blending component 133 at a rotational speed ranging between about 30,000 RPM and about 33,000 RPM (e.g., during a first power mode of operation).

Blending control circuitry 17, to control electrical motor 14, may select and/or use one of the first power mode of operation and the second power mode of operation based on the second detection of at least one of the first and the second type of detections. That is, one of the first power mode of operation and the second power mode of operation may be selected by blending control circuitry 17 based on the first detection indicating whether the heating mode is being used or the cooling mode, based on the second detection only indicating which of the first power mode of operation or the second power mode of operation to use (without indication of usage of the heating mode or cooling mode), or both. That is, blending control circuitry 17 selecting and/or using one of the different power modes of operations based on both the first and the second type of detections means that the user may have indicated via control interface 29 the temperature request (e.g., heating mode or cooling mode via the first button) and the power mode of operation to use via control interface 29 (e.g., the first or second power mode of operation via the second button). Blending control circuitry 17 selecting and/or using one of the different power modes of operations based on the second detection only indicating which of the first power mode of operation or the second power mode of operation to use means that the user may not have indicated the temperature request just the power mode of operation to use. Blending control circuitry 17 selecting and/or using one of the different power modes of operations based on the first detection may mean that the heating mode corresponds to one of the power modes of operations (e.g., the first power mode of operation) and the cooling mode corresponds to one of the power modes of operations (e.g., the first power mode of operation too, or the second power mode of operation).

For example, the heating mode may be used and/or selected by temperature control circuitry 27. The first power mode of operation may be used and/or selected by blending control circuitry 17 responsive to a combination of different detections, such as, by way of non-limiting example, the first detection (being of the first type of detections) that the first button has been pushed to indicate the first selection of the heating mode and the second detection (being of the second type of detections) that the second button has been pushed.

For example, the cooling mode may be used and/or selected by temperature control circuitry 27. The second power mode of operation may be used and/or selected by blending control circuitry 17 responsive to a combination of the first detection (being of the first type of detections) that the first button has been pushed to indicate the second selection of the cooling mode and the second detection.

In some implementations, blending control circuitry 17 may be configured to control operation of control interface 29 to enable transitions between different modes of operation. The transitions may include a first, second, third, fourth, fifth transition, and so forth. For example, a first transition may be from a ready-to-blend mode to the first power mode of operation. In some implementations, the first transition may occur responsive to an occurrence of the first type of detections (in the ready-to-blend mode). For example, a second transition may be to the second power mode of operation, and so forth. In some implementations, the second transition may occur responsive to an occurrence of the second and/or other types of detections.

In some implementations, control by a user of blender 100 may be based on a switch (not shown), a button, and/or other types of user interfaces suitable to turn consumer appliances on and off. Control interface 29 (e.g., through one or more light-emitting components) may be configured to illuminate in various colors (red, blue, purple, etc.) and/or patterns (solid, fast blinking, slow blinking, alternating red and blue, etc.). Control interface 29 may convey information regarding the operational status of blender 100 to a user. The operational status of blender 100 may be determined by blending control circuitry 17 and temperature control circuitry 27. Control interface 29 may be controlled by blending control circuitry 17. For example, if control interface 29 is solid purple, blender 100 may be charging and/or insufficiently charged to blend. For example, if control interface 29 is solid green, blender 100 may be ready for blending (e.g., in the ready-to-blend mode). For example, if control interface 29 is alternating red and blue, blender 100 may not be ready for blending due to base assembly 11 and container assembly 12 not being coupled properly and/or fully. For example, if control interface 29 is flashing purple, blender 100 may not be ready for charging and blending due to base assembly 11 and charging structure 21 not being mechanically coupled properly and/or fully. For example, in some implementations, threaded couplings between assembly 11 and container assembly 12 may need to be tightened sufficiently for proper operation of blender 100, and control interface 29 may warn the user when the threaded couplings are not tightened sufficiently and/or correctly. For example, if control interface 29 is solid blue, blender 100 may be in the cooling mode. For example, if control interface 29 is solid red, blender 100 may be in the heating mode.

In some implementations, blending control circuitry 17 may be configured to support an empty-battery power mode of operation, during which no electrical power is provided by (and/or insufficient electrical power is available through) the rechargeable battery, but power is provided to electrical motor 14 through one or more of wireless charging interface 31 of FIG. 1B and other power sources 25.

In some implementations, blender 100 may have fewer components then depicted in FIG. 1A.

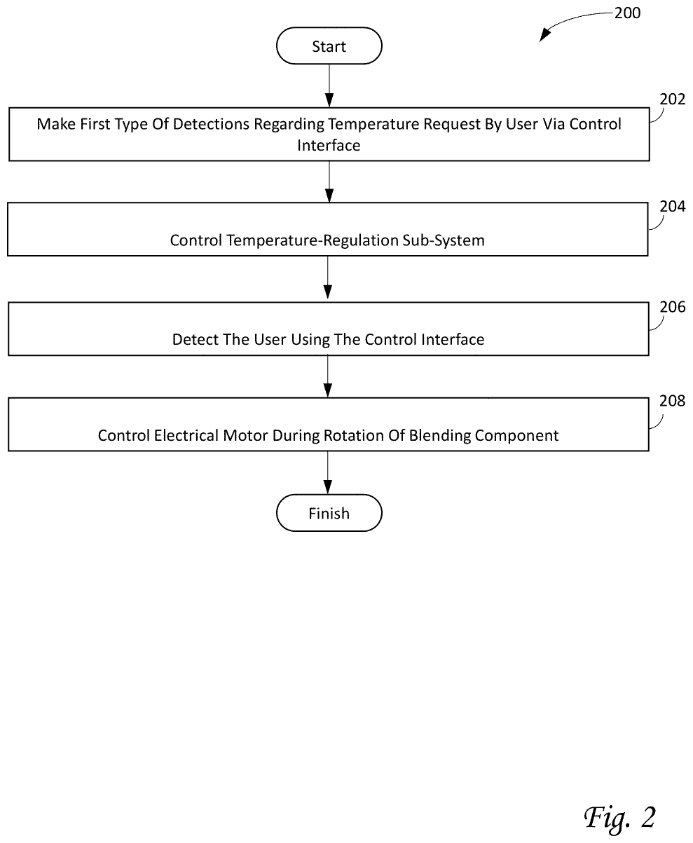

FIG. 2 illustrates a method 200 for controlling temperature and operation of a blender using different temperature-regulation modes and/or power modes to heat, cool, and blend foodstuffs within a container body of the blender, in accordance with one or more implementations. The operations of method 200 presented below are intended to be illustrative. In some implementations, method 200 may be accomplished with one or more additional operations not described, and/or without one or more of the operations discussed. Additionally, the order in which the operations of method 200 are illustrated in FIG. 2 and described below is not intended to be limiting.

In some implementations, method 200 may be implemented using one or more processing devices (e.g., a digital processor, an analog processor, a digital circuit designed to process information, an analog circuit designed to process information, a state machine, and/or other mechanisms for electronically processing information). The one or more processing devices may include one or more devices executing some or all of the operations of method 200 in response to instructions stored electronically on an electronic storage medium. The one or more processing devices may include one or more devices configured through hardware, firmware, and/or software to be specifically designed for execution of one or more of the operations of method 200.

At an operation 202, a first type of detections is made regarding a temperature request by a user via a control interface. In some embodiments, operation 202 is performed by a control circuitry the same as or similar to temperature control circuitry 27 (shown in FIG. 1A and described herein). In some implementations, operation 202 may be skipped or automated.

At an operation 204, a temperature-regulation sub-system is controlled using one or more different temperature-regulation modes, e.g., based on a first detection of the first type of detections. In some embodiments, operation 204 is performed by control circuitry the same as or similar to temperature control circuitry 27 (shown in FIG. 1A and described herein).

At an operation 206, a particular type of detections is made regarding the user using the control interface. In some embodiments, operation 206 is performed by control circuitry the same as or similar to blending control circuitry 17 (shown in FIG. 1A and described herein).

At an operation 208, electrical power is controlled during rotation of blending component. In some implementations, operation 210 may be based on one or more detections of at least one of a first and a second type of detections. In some embodiments, operation 210 is performed by control circuitry the same as or similar to blending control circuitry 17 (shown in FIG. 1A and described herein).

Although the present technology has been described in detail for the purpose of illustration based on what is currently considered to be the most practical and preferred implementations, it is to be understood that such detail is solely for that purpose and that the technology is not limited to the disclosed implementations, but, on the contrary, is intended to cover modifications and equivalent arrangements that are within the spirit and scope of the appended claims. For example, it is to be understood that the present technology contemplates that, to the extent possible, one or more features of any implementation can be combined with one or more features of any other implementation.

What is claimed is:

1. A blender configured to heat, cool, and blend foodstuffs within a container body, the blender comprising:
a base assembly, a container assembly, a blending component, a control interface, temperature control circuitry, and blending control circuitry,
wherein the blending component is configured to rotate around a rotational axis and blend the foodstuffs during blending by the blender,
wherein the base assembly includes:
an electrical motor configured to drive rotation of the blending component; and
a temperature-regulation sub-system configured to regulate a temperature of the foodstuffs within the container body during use of the blender by a user, wherein the temperature-regulation sub-system includes one or more heating components and/or one or more cooling components; and
one or more power sources configured to conduct electrical power to the electrical motor and to the temperature-regulation sub-system;
wherein the container assembly is configured to hold the foodstuffs within the container body during blending by the blender;
wherein the control interface is configured to control operation of the blender and regulate the temperature of the foodstuffs upon usage of the control interface by the user;
wherein the temperature control circuitry is configured to:
control the temperature-regulation sub-system using one or more different temperature-regulation modes, including a cooling mode and/or a heating mode, wherein:
(i) responsive to selection of the heating mode, a first amount of electrical power is provided by the one or more power sources to the one or more heating components to increase the temperature of the foodstuffs within the container body by at least one of providing heat and removing cool air;
(ii) responsive to selection of the cooling mode, a second amount of electrical power is provided by the one or more power sources to the one or more cooling components to decrease the temperature of the foodstuffs within the container body by at least one of cooling the foodstuffs and removing warm air;
wherein the blending control circuitry is configured to:
make one or more detections regarding the user using the control interface; and
control the electrical motor during the rotation of the blending component, wherein:
during blending, electrical power is provided by the one or more power sources to the electrical motor, such that the blending component rotates and blends the foodstuffs within the container body.

2. The blender of claim 1, wherein the control interface includes buttons configured to be pushed by the user, wherein a first type of detections includes detecting push combinations of a first button included in the buttons that indicate whether a temperature request corresponds to a first selection of the heating mode or a second selection of the cooling mode, and wherein the temperature control circuitry is configured to control the temperature-regulation sub-system based on a first detection of the first type of detections.

3. The blender of claim 2, wherein the temperature control circuity is configured to effectuate at least one of the providing of heat and the removing cool air by providing the electrical power to the heating components using the heating mode, wherein the blending control circuitry is configured to control the electrical motor using a first power mode of operation, wherein during the first power mode of operation, a third amount of electrical power is provided by the one or more power sources to the electrical motor such that the blending component is configured to rotate at a first rotational speed, wherein the first rotational speed is limited in the first power mode of operation by a first rotational speed limit.

4. The blender of claim 3, wherein the one or more heating components include:
one or more of a thermoelectric generator, one or more electric radiators, a fan to distribute heat generated by one or both of the thermoelectric generator and the one or more electric radiators to provide heat; and/or
an exit fan and an outlet valve that transfers the cool air through the outlet value out of the base assembly to an atmosphere to remove the cool air.

5. The blender of claim 2, wherein responsive to:
(i) the first detection of the first type of detections that the first button has been pushed to indicate the second selection of the cooling mode, and
(ii) a second detection of a second type of detections that one or more of the buttons have been pushed,
the temperature control circuity is configured to effectuate at least one of the cooling of the foodstuffs and the removing of warm air by providing the electrical power to the cooling components using the cooling mode and the blending control circuitry is configured to control the electrical motor using a second power mode of operation, wherein during the second power mode of operation, a fourth amount of electrical power is provided by the one or more power sources to the electrical motor such that the blending component is configured to rotate at a second rotational speed, wherein the second rotational speed is limited in the second power mode of operation by a second rotational speed limit.

6. The system of claim 5, wherein the cooling components include:
one or more of a thermoelectric cooler, a heat sink, an intake fan that draws in cooler air, an exhaust fan that expels warm air to an atmosphere of the user, an outlet value attached to the exhaust fan to expelling the warm air to the atmosphere, and a synthetic jet air cooling.

7. The blender of claim 1, wherein the power sources are configured to further conduct electrical power to a rechargeable battery, wherein the power sources include a wireless charging interface and a universal serial bus (USB) port, wherein the rechargeable battery is configured to power the electrical motor.

8. The system of claim 2, wherein the base assembly includes a temperature sensor configured to determine an interior temperature of the container body containing the foodstuffs, wherein the temperature control circuitry is configured to make a third type of detections regarding the interior temperature of the container body relative to a cool threshold and a heat threshold, and based on the temperature sensor.

9. The system of claim 8, wherein responsive to:
(i) the first detection of the first type of detections that the first button has been pushed to indicate the second selection of the cooling mode, and
(ii) the second detection of the second type of detections that the button has been pushed,
(iii) a third detection of the third type of detections that the interior temperature is above the cool threshold,
the temperature control circuity is configured to effectuate at least one of the cooling of the foodstuffs and the removing of warm air by providing the electrical power, using the cooling mode, to two or more of the cooling components.

10. The system of claim 8, wherein responsive to:
(i) the first detection of the first type of detections that the first button has been pushed to indicate the first selection of the heating mode, and
(ii) the second detection of the second type of detections that the button has been pushed,
(iii) a third detection of the third type of detections that the interior temperature is below the heat threshold,
the temperature control circuity is configured to effectuate at least one of the providing of heat and the removing cool air by providing the electrical power, using the heating mode, to two or more of the heating components.

11. A method for heating, cooling, and blending foodstuffs within a container body, wherein the blender includes a blending component, a control interface, an electrical motor, one or more power sources, and a temperature-regulation sub-system, the method comprising:
controlling the temperature-regulation sub-system using one or more different temperature-regulation modes, including a cooling mode and/or a heating mode, wherein:
(i) responsive to selection of the heating mode, a first amount of electrical power is provided by the one or more power sources to one or more heating components to increase the temperature of the foodstuffs within the container body by at least one of providing heat and removing cool air;
(ii) responsive to selection of the cooling mode, a second amount of electrical power is provided by the one or more power sources to one or more cooling components to decrease the temperature of the foodstuffs within the container body by at least one of cooling the foodstuffs and removing warm air;
making one or more detections regarding the user using the control interface; and
controlling the electrical motor during the rotation of the blending component, wherein:
during blending, electrical power is provided by the one or more power sources to the electrical motor, such that the blending component rotates and blends the foodstuffs within the container body.

12. The method of claim 11, wherein the control interface includes buttons configured to be pushed by the user, wherein a first type of detections includes detecting push combinations of a first button included in the buttons that indicate whether a temperature request corresponds to a first selection of the heating mode or a second selection of the cooling mode, and wherein the temperature control circuitry controls the temperature-regulation sub-system based on a first detection of the first type of detections.

13. The method of claim 12, further comprising:
providing the electrical power to the one or more heating components using the heating mode; and
controlling the electrical motor using a first power mode of operation, wherein during the first power mode of operation, a third amount of electrical power is provided by the one or more power sources to the electrical motor such that the blending component is configured to rotate at a first rotational speed, wherein the first rotational speed is limited in the first power mode of operation by a first rotational speed limit.

14. The method of claim 13, wherein the one or more heating components include:
one or more of a thermoelectric generator, one or more electric radiators, a fan to distribute heat generated by one or both of the thermoelectric generator and the one or more electric radiators to provide heat; and/or
an exit fan and an outlet valve that transfers the cool air through the outlet value out of the base assembly to an atmosphere to remove the cool air.

15. The method of claim 12, wherein responsive to:
(i) the first detection of the first type of detections that the first button has been pushed to indicate the second selection of the cooling mode, and
(ii) a second detection of a second type of detections that one or more of the buttons have been pushed, further comprising:
providing the electrical power to the one or more cooling components using the cooling mode; and
controlling the electrical motor using a second power mode of operation, wherein during the second power mode of operation, a fourth amount of electrical power is provided by the one or more power sources to the electrical motor such that the blending component is configured to rotate at a second rotational speed, wherein the second rotational speed is limited in the second power mode of operation by a second rotational speed limit.

16. The method of claim 15, wherein the one or more cooling components include:
one or more of a thermoelectric cooler, a heat sink, an intake fan that draws in cooler air, an exhaust fan that expels warm air to an atmosphere of the user, an outlet value attached to the exhaust fan to expelling the warm air to the atmosphere, and a synthetic jet air cooling.

17. The method of claim 11, wherein the power sources are configured to further conduct electrical power to a rechargeable battery, wherein the power sources include a wireless charging interface and a universal serial bus (USB) port, wherein the rechargeable battery is configured to power the electrical motor.

18. The method of claim 12, wherein the base assembly includes a temperature sensor configured to determine an interior temperature of the container body containing the foodstuffs, further comprising making a third type of detections regarding the interior temperature of the container body relative to a cool threshold and a heat threshold, and based on the temperature sensor.

19. The method of claim 18, wherein responsive to:
(i) the first detection of the first type of detections that the first button has been pushed to indicate the second selection of the cooling mode, and
(ii) the second detection of the second type of detections that the button has been pushed,
(iii) a third detection of the third type of detections that the interior temperature is above the cool threshold, further comprising:
providing the electrical power, using the cooling mode, to two or more of the cooling components.

20. The method of claim 18, wherein responsive to:
(i) the first detection of the first type of detections that the first button has been pushed to indicate the first selection of the heating mode, and
(ii) the second detection of the second type of detections that the button has been pushed,
(iii) a third detection of the third type of detections that the interior temperature is below the heat threshold, further comprising:
providing the electrical power, using the heating mode, to two or more of the heating components.
